(19) United States
(12) Patent Application Publication
(10) Pub. No.: US 2011/0119465 A1
(43) Pub. Date: May 19, 2011

(54) DATA PROCESSING SYSTEM

(75) Inventors: Takayuki SUZUKI, Sagamihara (JP); Nobuaki Kohinata, Yokohama (JP); Takashi Matsumoto, Kawasaki (JP)

(73) Assignee: RENESAS ELECTRONICS CORPORATION

(21) Appl. No.: 12/946,364

(22) Filed: Nov. 15, 2010

(30) Foreign Application Priority Data
Nov. 16, 2009 (JP) 2009-260738

(51) Int. Cl. G06F 12/02

(52) U.S. Cl. 711/171; 711/E12.002

(57) ABSTRACT

The data processing system including: a memory block; a data-processing control block; a demultiplex-processing block; a multiplex-processing block; a decode-processing block; and an encode-processing block. In the system, the demultiplex-processing block, multiplex-processing block, decode-processing block, and encode-processing block each execute a process using memory regions in the memory block. During the execution, the data-processing control block changes a memory region to assign to the processing in response to a processing request based on results of processing which the block concerned executed in response to the preceding processing request. With the data processing system, a memory region can be used effectively even if a memory region size required for processing cannot be determined in advance.

### CLAIM OF PRIORITY

The Present application claims priority from Japanese application JP 2009-260738 filed on Nov. 16, 2009, the content of which is hereby incorporated by reference into this application.

### FIELD OF THE INVENTION

The present invention relates to a data processing system which handles stream data of contents, and a technique useful in application to embedded devices, e.g. mobile phones and other on-vehicle devices, which are severely limited in use of data storage regions.

### BACKGROUND OF THE INVENTION

Software programs for embedded devices are required to effectively use an available data region, i.e. memory region. This is because the size and price of devices which the programs are designed for, and other factors impose restrictions on them. Embedded devices are often limited in functions offered as products. In such case, details of a process to be conducted by each software program are confined. Therefore, in regard to an embedded device, once details of a process to be executed by a software program and a processing method therefor are decided, the memory region necessary for the program to execute the process can be determined, and thereafter the size of the memory region remains unchanged.

Because of the circumstances, it has been suggested, for a device restricted in function like an embedded device, to adopt a method by which a memory region partitioned in advance is used. In regard to a prior art involving such method, e.g. Japanese Unexamined Patent Publication JP-A-6-103159 makes a disclosure.

In the case of the method as described in the patent document JP-A-6-103159, a memory region necessary for a processing block to conduct a process is estimated in advance. Further, when executing a process, the processing block reserves a memory region selected from among one of memory region groups having different fixed memory sizes, into which memory regions have been classified according to the sizes thereof in advance, provided that the size of the reserved memory region is the smallest of the fixed sizes of the memory region groups, and is equal to or larger than the memory size required for the process execution.

### SUMMARY OF THE INVENTION

However, the method as described in the patent document JP-A-6-103159 involves estimating a memory region necessary for processing. Therefore, even if the method is applied to a system having difficulty in previously estimating a required memory region, it would be impossible to use the memory region effectively. An example of such application is a case where the method is adopted for an embedded device which conducts the reproduction of stream data of video contents and others with changing bit rates. Even if such embedded device makes an attempt to reproduce multiplexed video contents data in MPEG2-TS (Moving Picture Expert Group2-Transport Stream) by GOP (Group Of Pictures), for example, the size of data resulting from the demultiplex of the contents data, and corresponding to one GOP remains undetermined until after execution of the actual demultiplex. Ina case where it is difficult to estimate the size of data resulting from a process, as described above, the size of a memory region required for the process execution must be determined based on some type of information. For example, the upper limit of a memory region size required for processing may be calculated based on the upper limit value specified by the specifications of a product concerned, the upper limit value specified by specifications of video contents data targeted for the processing, or the like. However, the size of a required memory region set by the method like this will probably include the size of a memory region which may not be used actually, and therefore an useless memory region will be reserved. Especially, there is a high probability that upper limit values specified by products' specifications or video contents' specifications are set to larger values than actually required ones to keep sufficient allowance, which will probably lower the efficiency of use of a memory region during reproduction. In addition, with an embedded device as described above, sometimes CPU or the like directs processing requests at software programs or hardware devices in charge of execution of processes for the purpose of efficiently conducting processes required for reproduction of video contents, e.g. demultiplex, decode of video contents data, and display of the video contents, and thus the processes are executed in parallel. In such case, data sizes or memory regions required for the processes must be determined before the processing requests are issued to the respective software programs or hardware devices. Therefore, with the method as described in the patent document JP-A-6-103159, it is sometimes difficult to reserve a required memory region after a required data size is found.

Therefore, it is an object of the invention to provide a data processing system which can use a memory region effectively even in a case where a memory region size required for processing cannot be determined in advance.

The above and other objects of the invention and novel features thereof will become apparent from the description hereof and the accompanying drawings.

Of preferred embodiments of the invention herein disclosed, representative one will be described in brief outline.

According to the embodiment of the invention, a data processing system is materialized; in the data processing system, a memory region to be assigned to the processing in response to each processing request associated with a process is changed based on the result of processing which a processing block in charge of the process conducted in response to the preceding processing request.

The effect achieved by the embodiment is briefly as follows.

A memory region can be used effectively even in a case where a memory region size required for processing cannot be determined in advance.

### BRIEF DESCRIPTION OF THE DRAWINGS

FIG. 1 is a diagram showing a data processing system according to an embodiment of the invention;

FIG. 2 is a diagram for explaining the data flow during reproduction;

FIG. 3 is a diagram for explaining the detail of the reproduction and data involved with it;

FIG. 4 is a diagram for explaining a method for assigning a fixed-size memory region in units of processing for comparison with a method for assigning a memory region associated with the embodiment of the invention;

FIG. 5 is a diagram for explaining the method for assigning a fixed-size memory region in units of processing, which shows an application of the method to a demultiplex process;

FIG. 6 is a diagram for explaining the flow of the demultiplex process, to which the method for assigning a fixed-size memory region in units of processing is applied;

FIG. 7 is a diagram for explaining a descriptor connected with the embodiment of the invention;

FIG. 8 is a diagram for explaining a method for assigning a memory region using the descriptor;

FIG. 9 is a diagram showing the flow of the demultiplex process to which the method for assigning a memory region using the descriptor is applied;

FIG. 10 is a diagram for explaining an example of effective use of a memory region connected with the embodiment of the invention;

FIG. 11 is a diagram for explaining a method for storing data using the descriptor connected with the embodiment of the invention;

FIG. 12 is a diagram showing the flow of the demultiplex process, to which the data-storing method using the descriptor according to the embodiment of the invention is applied;

FIG. 13 is a diagram for explaining the flow of the demultiplex process to which a data-storing method using a fixed-size memory region is applied for comparison with the method for storing data using the descriptor;

FIG. 14 is a diagram for explaining a method for reading data using the descriptor associated with the embodiment of the invention;

FIG. 15A is a diagram for explaining a data-storing method based on the wrap-around technique associated with the embodiment of the invention;

FIG. 15B is a diagram for explaining a first data-storing method based on the wrap-around technique, as the first example of the data-storing method described with reference to FIG. 15A;

FIG. 15C is a diagram for explaining a second data-storing method based on the wrap-around technique, as the second example of the data-storing method described with reference to FIG. 15A;

FIG. 16 is a diagram showing a method for reading data arranged to fit the first data-storing method;

FIG. 17 is a diagram showing a method for reading data arranged to fit the second data-storing method;

FIG. 18 is a diagram showing the data flow during recording associated with the embodiment of the invention; and

FIG. 19 is a diagram for explaining details of the recording and data connected with it.

### DETAILED DESCRIPTION OF THE PREFERRED EMBODIMENTS

First, preferred embodiments of the invention herein disclosed will be outlined. Here, the reference numerals to refer to the drawings, which are accompanied with paired round brackets, only exemplify what the concepts of components or constituent features referred to by the numerals include.

[1] Materialized as a preferred embodiment of the invention is a data processing system (10) having: a memory block (102) for storing data; a data-processing control block (101) which assigns a memory region of the memory block for storing results of processing of stream data; a demultiplex-processing block (103) which demultiplexes multiplexed encoded data using the memory region assigned thereto on receipt of each processing request; and a decode-processing block (40) which decodes the demultiplexed encoded data using the memory region assigned thereto on receipt of each processing request. The data-processing control block puts at least one of the demultiplex-processing block and decode-processing block under its control, and the data-processing control block changes a memory region to assign for each processing request based on results of processing conducted by the at least one block in response to a processing request precedent thereto. According to the above-described arrangement, even if a memory region actually used is smaller in size than a memory region assigned for processing, a memory region to assign for the subsequent processing request is decided based on the actually used memory region. Therefore, it is possible to use the memory region effectively.

[2] As to the data processing system as described in [1], the data-processing control block attaches a descriptor (702-706) to each processing request of the at least one block; the descriptor is referred to when storing, in a memory region assigned for each processing request, results of processing conducted by the at least one block in response to the processing request. According to the above-described arrangement, it becomes easier to assign a memory region for each processing request.

[3] As to the data processing system as described in [2], the descriptor includes: data of a beginning address of an available memory region in the memory block; and data which specifies a size of the available memory region.

[4] As to the data processing system as described in [3], each time the at least one block completes processing to conduct on receipt of each processing request, the data-processing control block changes the beginning address data of the descriptor based on the size of the memory region where results of the completed processing have been stored, and attaches the changed descriptor to a subsequent processing request. According to the above-described arrangement, a memory region to assign for the subsequent processing request can be decided easily.

[5] As to the data processing system as described in [1], the memory block has a descriptor (1201) for storing results of processing by the at least one block in a memory region for each processing request. Further, the descriptor includes: a first pointer (1211) indicating an address of a memory region to store results of processing in response to a new processing request in; effective size data showing a size of a memory region with effective results of processing held therein; and a second pointer (1212) indicating an address of a memory region which has been released by reading results of processing therefrom. Moreover, the at least one block puts results of processing in response to a processing request in a memory region assigned therefor using the first and second pointers, in a first-in, first-out mode. According to the above-described arrangement, the at least one block can store in/read from the memory region, results of processing conducted in response to a processing request in the order in which the processing is performed. Thus, an effective use of a memory region can be achieved easily.

[6] As to the data processing system as described in [5], on condition that a difference between a value of the first pointer and an end address of the memory region is smaller than a required maximum memory size, the at least one block controls its action on the memory region according to a wrap-around technique. Under the control according to the wrap-around technique, results of processing in response to a new processing request are stored in the memory region from its beginning address. According to the above-described arrangement, results of processing conducted in response to one processing request are never segmented and thus stored in pieces of data.

[7] As to the data processing system as described in [5], on condition that a difference between a value of the first pointer and an end address of the memory region is smaller than a required maximum memory size, the at least one block controls its action on the memory region according to a wrap-around technique. Under the control according to the wrap-around technique, results of processing in response to a new processing request are stored according to a value of the first pointer.

[8] As to the data processing system as described in [6], on condition that the effective size data is equal to the difference between the value of the first pointer and the beginning address of the memory region, the at least one block reads data stored in the memory region from its beginning address when reading results of processing in response to a processing request from the memory region. According to the above-described arrangement, even if there is a memory region with no data stored therein, a memory region with effective data stored therein can be found and the effective data can be read from there.

[9] Materialized as a preferred embodiment of the invention is a data processing system having: a memory block (102) for storing data; a data-processing control block (101) which assigns a memory region of the memory block for storing results of processing of stream data; an encode-processing block (50) which encodes input data using the memory region assigned thereto on receipt of each processing request; and a multiplex-processing block (108) which multiplexes the encoded data using the memory region assigned thereto on receipt of each processing request. In the data processing system, the data-processing control block puts at least one of the encode-processing block and multiplex-processing block under its control, and the data-processing control block changes a memory region to assign for each processing request based on results of processing conducted by the at least one block in response to a processing request precedent thereto. According to the above-described arrangement, the same effects as those achieved by the arrangement as described in [1] are attained.

[10] As to the data processing system as described in [9], the data-processing control block attaches a descriptor to each processing request of the at least one block, and the descriptor is referred to when storing, in a memory region assigned for each processing request, results of processing conducted by the at least one block in response to the processing request. According to the above-described arrangement, the same effects as those achieved by the arrangement as described in [2] are attained.

[11] As to the data processing system as described in [9], the memory block has a descriptor (1201) for storing results of processing by the at least one block in a memory region for each processing request. Further, the descriptor includes: a first pointer (1211) indicating an address of a memory region to store results of processing in response to a new processing request in; effective size data showing a size of a memory region with effective results of processing held therein; and a second pointer (1212) indicating an end address of a memory region which has been released by reading results of processing therefrom. Moreover, the at least one block puts results of processing in response to a processing request in a memory region assigned therefor using the first and second pointers, in a first-in, first-out mode. According to the above-described arrangement, the same effects as those achieved by the arrangement as described in [5] are attained.

[12] Materialized as a preferred embodiment of the invention is a data processing system having: a memory block (102) for storing data; a data-processing control block (101) which assigns a memory region of the memory block for storing results of processing of stream data; a demultiplex-processing block (103) which demultiplexes multiplexed encoded data using the memory region assigned thereto on receipt of each processing request; a decode-processing block (40) which decodes the demultiplexed encoded data using the memory region assigned thereto on receipt of each processing request; an encode-processing block (50) which encodes input data using the memory region assigned thereto on receipt of each processing request; and a multiplex-processing block (108) which multiplexes the encoded data using the memory region assigned thereto on receipt of each processing request. In the data processing system, the data-processing control block puts at least one of the demultiplex-processing block, decode-processing block, encode-processing block, and multiplex-processing block under its control, and the data-processing control block changes a memory region to assign for each processing request based on results of processing conducted by the at least one block in response to a processing request precedent thereto. According to the above-described arrangement, the same effects as those achieved by the arrangement as described in [1] are attained.

### Further Detailed Description of the Preferred Embodiments

Now, the preferred embodiments will be described further in detail.

### <<Overview of a Data Processing System According to the Embodiment>>

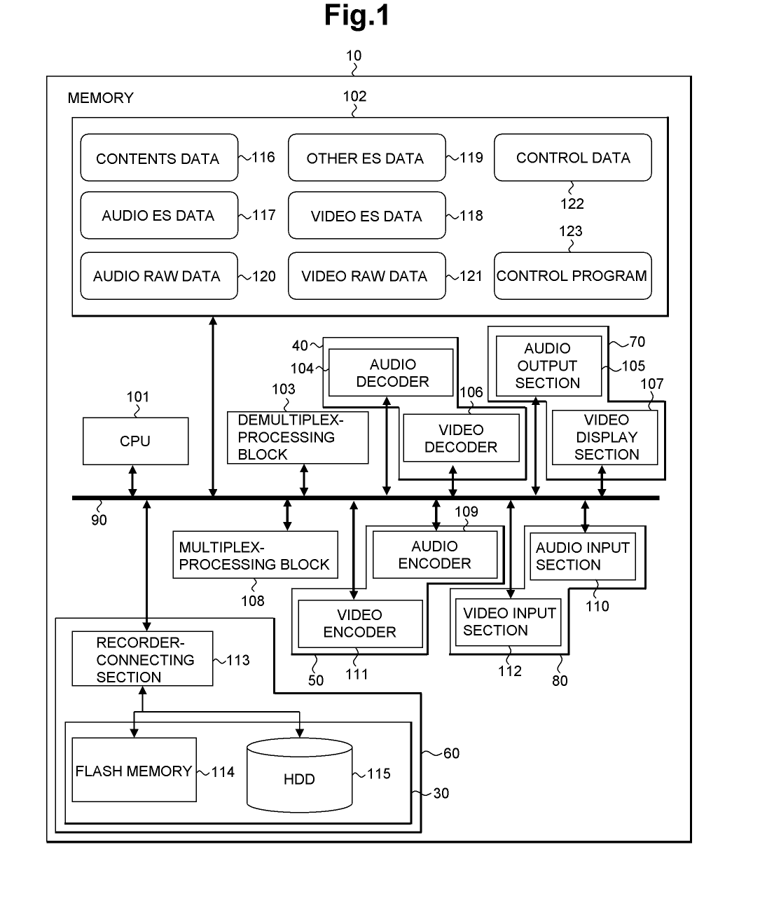

FIG. 1 shows a data processing system according to an embodiment of the invention, which reproduces stream data of video contents and others, and records video and audio data input from the outside thereof.

The data processing system 10 shown in FIG. 1 includes: data-processing control block 101; a memory block 102; a recording block 60; a demultiplex-processing block 103; a multiplex-processing block 108; a decode-processing block 40; an encode-processing block 50; an input block 80; an output block 70; a bus 90; and a device, such as an external input/output interface, which is not shown in the drawing.

The data processing system 10 performs reproduction, which includes: demultiplexing multiplexed stream data of video contents and others stored in the recording block 60 into video and audio data by use of the demultiplex-processing block 103; decoding the video and audio data thus demultiplexed by use of the decode-processing block 40; and outputting the resultant data through the output block 70. Also, the data processing system 10 performs recording, which includes: encoding video and audio captured through the input block 80 by use of the encode-processing block 50; multiplexing the data thus encoded by use of the multiplex-processing block 108; and storing the resultant data in the recording block 60.

When the data processing system 10 performs the reproduction and recording, the demultiplex-processing block 103, decode-processing block 40, multiplex-processing block 108, and encode-processing block 50 execute the respective processes under their charges, using memory regions in the memory block 102. At time of the executions thereof, the data-processing control block 101 puts the demultiplex-processing block 103, multiplex-processing block 108, decode-processing block 40, and encode-processing block 50 under its control, and assigns available memory regions in the memory block 102 in units of processing in the processing blocks, in order to effectively use the memory regions. Now, it is noted that the demultiplex-processing block 103, multiplex-processing block 108, decode-processing block 40, and encode-processing block 50 are each hereinafter referred to as “CPU-controlled block” for the sake of convenience.

Now, the constituent parts of the data processing system 10 will be described in detail.

The data-processing control block 101 has a comprehensive control of the blocks as described above, and in this condition, the blocks execute the reproduction and recording of video contents and others, and other process. An example of the data-processing control block 101 is CPU. The description below will be presented on the assumption that the data-processing control block 101 is composed of CPU 101.

Under the control of CPU 101, the demultiplex-processing block 103 demultiplexes contents data, which are multiplexed stream data of video contents and others stored in the recording block 60, and separates the data into encoded audio data (hereinafter referred to as “audio ES data”), and encoded video data (hereinafter referred to as “video ES data”). Incidentally, “ES” stands for Elementary Stream.

The decode-processing block 40 decodes the audio ES data and video ES data under the control of CUP 101. The decode-processing block 40 has an audio decoder section 104 and a video decoder section 106. The audio decoder section 104 decodes the audio ES data, and thereby outputs audio Raw data. The video decoder section 106 decodes the video ES data, and thereby outputs video Raw data.

The output block 70 is a device serving to output video contents and others, which includes a video display section 107 operable to display a video image and an audio output section 105 operable to output sound. The video display section 107 accepts inputs of video Raw data, and outputs an video image. The video display section 107 is composed of a liquid crystal display device, for example. The audio output section 105 accepts inputs of the audio Raw data, and outputs sound. The audio output section 105 is composed of a speaker, for example. While the output block 70 is provided in the data processing system 10, an external device equivalent thereto in function may be connected from the outside instead of it. For instance, the data processing system 10 may be arranged to output the audio Raw data and video Raw data through an external output interface (not shown) of the data processing system 10, and to reproduce a video image and sound by use of a speaker and display device placed outside.

The input block 80 is a device serving to take in video and audio data from the outside, which includes: a video input section 112 operable to take in an image, and an audio input section 110 operable to take in sound. The video input section 112 outputs video Raw data resulting from conversion of an image taken thereinto to electric signals. The video input section 112 is composed of a camera, for example. The audio input section 110 outputs audio Raw data resulting from conversion of sound taken thereinto to electric signals. The audio input section 110 is composed of a microphone, for example. As in the output block 70, the input block 80 is provided in the data processing system 10, however an external device equivalent thereto in function may be connected from the outside instead of it. For instance, the data processing system 10 may be arranged to accept inputs of the audio Raw data and video Raw data produced by a camera and microphone placed outside, through an external input interface (not shown) provided therein.

The encode-processing block 50 encodes the audio Raw data and video Raw data under the control of CPU 101. The encode-processing block 50 has an audio encoder section 109 and a video encoder section 111. The audio encoder section 109 encodes the audio Raw data, and thereby outputs the audio ES data. The video encoder section 111 encodes the video Raw data, and thereby outputs the video ES data.

The multiplex-processing block 108 multiplexes the video ES data, audio ES data and other ES data, resulting from encoding by the encode-processing block 50, and thus creates contents data, under the control of the CPU 101. The contents data thus created are stored in the recording block 60.

The recording block 60 records the contents data and others. The recording block 60 has a recorder-connecting section 113 and a recorder 30. The recorder 30 is an external storage device, and is connected to the bus 90 through the recorder-connecting section 113, into which the contents data and others are written. The recorder 30 is e.g. a nonvolatile recorder, which is composed of HDD (Hard Disk Drive), a flash memory, or the like. In FIG. 1, HDD 115 and a flash memory 114 are shown as typical examples. The recorder 30 may be incorporated in the system. Whether or not to so arrange the recorder depends on the system.

The recorder-connecting section 113 is an interface circuit for connection with the recorder 30, which controls data read and data write on the recorder 30, and other actions under the control of CPU 101 or the like. Specifically, the recorder-connecting section 113 may be composed of an interface circuit for ATA (Advanced Technology Attachment) or USB (Universal Serial Bus), or an interface circuit for connecting other external storage device.

The memory block 102 is a device having a memory region where data of results of processes by the respective processing blocks and the like are temporarily stored under the control of CPU 101 and other device. The memory block 102 is composed of e.g. a volatile memory.

The memory block 102 holds contents data 116, audio ES data 117, video ES data 118, other ES data 119, audio Raw data 120, video Raw data 121, etc. Also, the memory block 102 holds a control program 123 and a control data 122. The control program 123 is e.g. a software program for controlling a device. The control data 122 consist of the results of processing by the software program. The control program 123 has been held in another nonvolatile storage block (not shown) in advance. The control program 123 is read out from the nonvolatile storage block into the memory block 102 at the time of execution of the software program concerned.

### <<Reproduction of Contents Data>>

The process of reproducing contents data in the data processing system 10 will be described in detail.

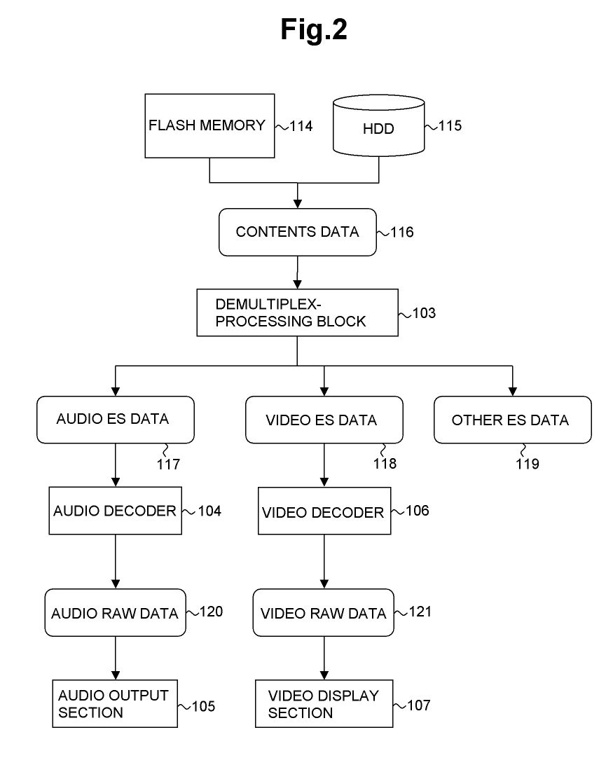

FIG. 2 is a diagram for explaining the data flow during reproduction.

In the drawing, data targeted for the reproduction are e.g. data in MPEG format.

In the reproduction, contents data 116 stored in the recorder 30 are read out, and temporarily put in the memory block 102, under the control of CPU 101, first. Subsequently, the contents data 116 held in the memory block 102 are input to the demultiplex-processing block 103, and undergo the demultiplex process by the demultiplex-processing block 103. As a result, audio ES data 117, video ES data 118 and other ES data 119 are output from there, and temporarily stored in the memory block 102.

The audio ES data 117 are fed to the audio decoder section 104 and subjected to a decode process. As a result, audio Raw data 120 is output therefrom. Likewise, the video ES data 118 are input to the video decoder section 106, and undergo the decode process. As a result, the video Raw data 121 are output from there. The output audio Raw data 120 are fed to the audio output section 105, and then output as sound, whereas the video Raw data 121 are input to the video display section 107 and output as a video image.

### <<Use of a Buffer During Reproduction>>

During reproduction, the demultiplex-processing block 103, audio decoder section 104, video decoder section 106, video display section 107 and audio output section 105 use part of the memory region of the memory block 102 as a buffer. Specifically, the processing blocks read out data stored in the buffer, execute respective processes, and temporarily store the results in the appropriate buffers.

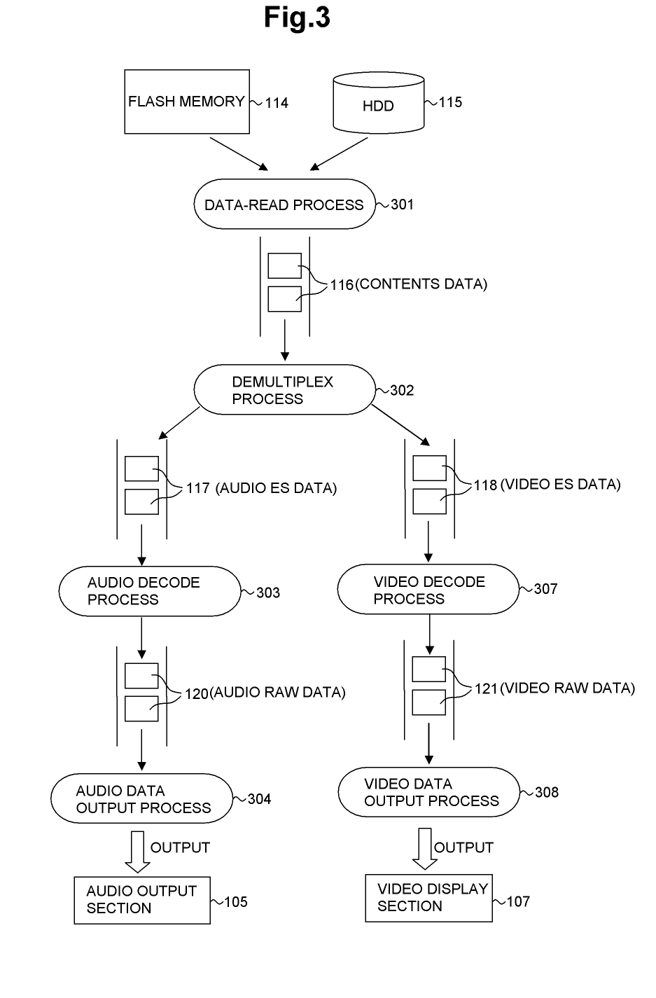

FIG. 3 is a diagram for explaining the detail of the reproduction and data involved with it.

In demultiplex process 302 shown in FIG. 3, a series of demultiplex processing conducted on one GOP of contents data is treated as the unit of processing thereof. However, the way to define the unit of processing like this is just an example. The unit of processing may be changed depending on e.g. the specifications of hardware which will execute the process, and details of the process to be conducted.

In shown in FIG. 3, contents data 116 read out in data-read process 301 as described above are stored in a given buffer. The demultiplex-processing block 103 read out the contents data 116 held in the buffer, executes the demultiplex process 302, stores the resultant audio ES data 117 in a buffer for storing audio ES data, and the resultant video ES data 118 in a buffer for storing video ES data. Then the audio decoder section 104 reads out the audio ES data 117 from the buffer for storing the audio ES data, executes audio decode process 303, and stores the resultant audio Raw data 120 in the buffer for storing audio Raw data. Likewise, the video decoder section 106 reads out the audio ES data 117, executes video decode process 307, and stores the resultant video Raw data 121 in the buffer for storing video Raw data. The audio output section 105 reads out the audio Raw data 120 from the buffer for storing audio Raw data, executes audio data output process 304, and outputs sound. Likewise, the video display section 107 reads out the video Raw data, executes video data output process 308, and display a video image.

As described above, the demultiplex-processing block 103, audio decoder section 104, video decoder section 106, video display section 107 and audio output section 105 read out data stored in the respective buffers, and execute the processes under their charges. Therefore, on condition that data called for by means of processing requests have been stored in the buffers, the processes involving these requests can be executed in series as well as in parallel. For example, as to the data-read process 301, contents data 116 can be read out to the extent that the buffer region to which the data are to be output can accept. Also, it is possible to execute the video decode process 307 while performing the video data output process 308 to display a video image.

### <<Memory Region Assignment During Reproduction>>

The sizes of the memory regions assigned as buffers for storing results of execution of processes and others can be statically defined to fit the details of the processes in the phase of designing the data processing system 10, in some cases. For example, on condition that the size of the contents data 116 to be read from the recorder 30 has been defined in advance, the size of the memory region of a buffer to store the contents data 116 in can be determined based on the defined size. In addition, the size of the buffer for storing results of the audio data output process 304 and video data output process 308 can be determined based on e.g. the specifications of the audio output section 105 and video display section 107, which are destinations of data resulting from the audio and video data output processes 304 and 308. However, it is difficult to previously define the size of the buffer for storing the results of the demultiplex process 302. This is because when performing the demultiplex process in given units of processing, e.g. GOP units, the size of data resulting from the demultiplex process varies depending on the bit rate of data compression at the time of recording contents data. Therefore, to order to determine the memory region of a buffer for the demultiplex process 302 in advance, it is required to calculate the maximum output data size from specifications of the product or specifications of compressed data format, and then determine the memory region based on the data size. Also, it is difficult to previously determine the size of the buffer for storing the audio Raw data 120 and video Raw data 121, which are output by the audio decoder section 104 and video decoder section 106 respectively. This is because data sizes of the audio ES data 117 and video ES data 118 before decoding, which are handled in the given units of processing, fluctuate.

Next, the method for assigning a memory region used as a buffer, which was devised in consideration of the circumstances, will be described below.

### <<Comparative Example for Comparison to a Method for Assigning a Memory Region According to an Embodiment of the Invention>>

Before a method for assigning a memory region according to an embodiment of the invention, a method for assigning a fixed-size memory region to each of processes conducted by the processing blocks will be described as an example for comparison to the method in connection with the invention.

Taken here is an application of the method for assigning a memory region to a data processing system such that CPU reserves a memory region for storing results of processing conducted by each processing block, and then issues a processing request. An example of creation of the video ES data involved with the demultiplex process in the data processing system will be described below.

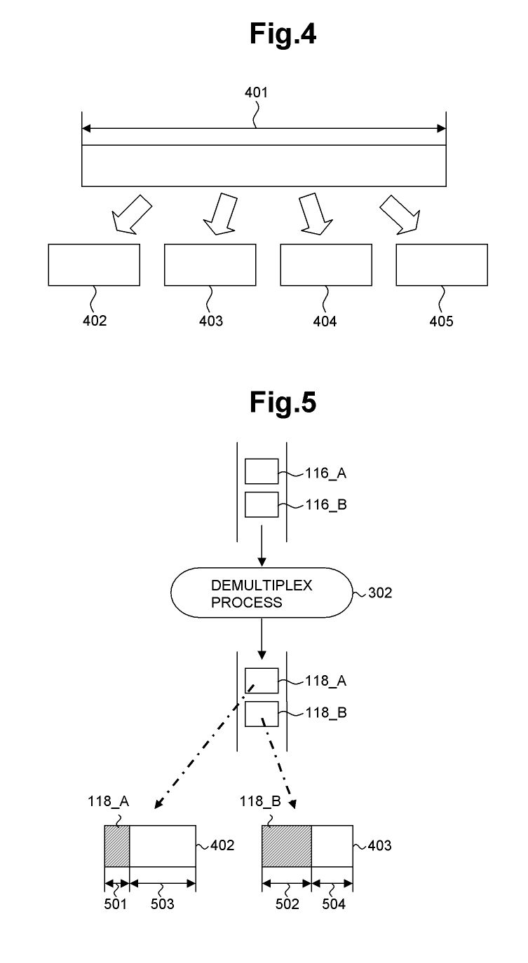

FIG. 4 is a diagram for explaining the method for assigning a fixed-size memory region to each process.

The description below covers, as an example, an application of the method for assigning a memory region to output of video ES data involved in the demultiplex process, which is one of the processes executed in the data processing system.

In the reproduction of contents data, the size of video ES data is remarkably larger than that of the control data 122 including results of processing by the control program 123 or the like. Therefore, it is often the case that the system under a severe memory restriction has an exclusive-use memory region for storing video ES data provided in the memory block 102. In FIG. 4, the reference numeral 401 denotes a memory region for demultiplex output, which is assigned for storing video ES data during processing. The region is further segmented into four segmental memory regions 402 to 405. Each segmental memory region represents an area used for one demultiplex process, i.e. an area used in response to one processing request issued in GOP units. The segmental memory regions are set based on the maximum output data size calculated from specifications of the product or specifications of compressed data format, and are fixed in size.

FIG. 5 is a diagram for explaining the method for assigning a fixed-size memory region in units of processing, which shows an application of the method to a demultiplex process.

In the example shown in the drawing, in response to inputs of contents data 116_A related to a processing request and contents data 116_B related to a subsequent processing request, the demultiplex-processing block 103 executes the demultiplex process 302 in response to each processing request thereby to produce video ES data 118_A and 118_B. The demultiplex-processing block 103 stores the video ES data 118_A and 118_B in the memory regions 402 and 403 on receipt of each processing request, provided that the memory regions 402 and 403 have been assigned on an individual processing request basis.

In the case of the method for assigning a memory region, the demultiplex-processing block 103 stores results of processing in a fixed-size memory region assigned for each processing request of the demultiplex process and as such, unused memory regions 503 and 504 will arise consequently, as shown in FIG. 5.

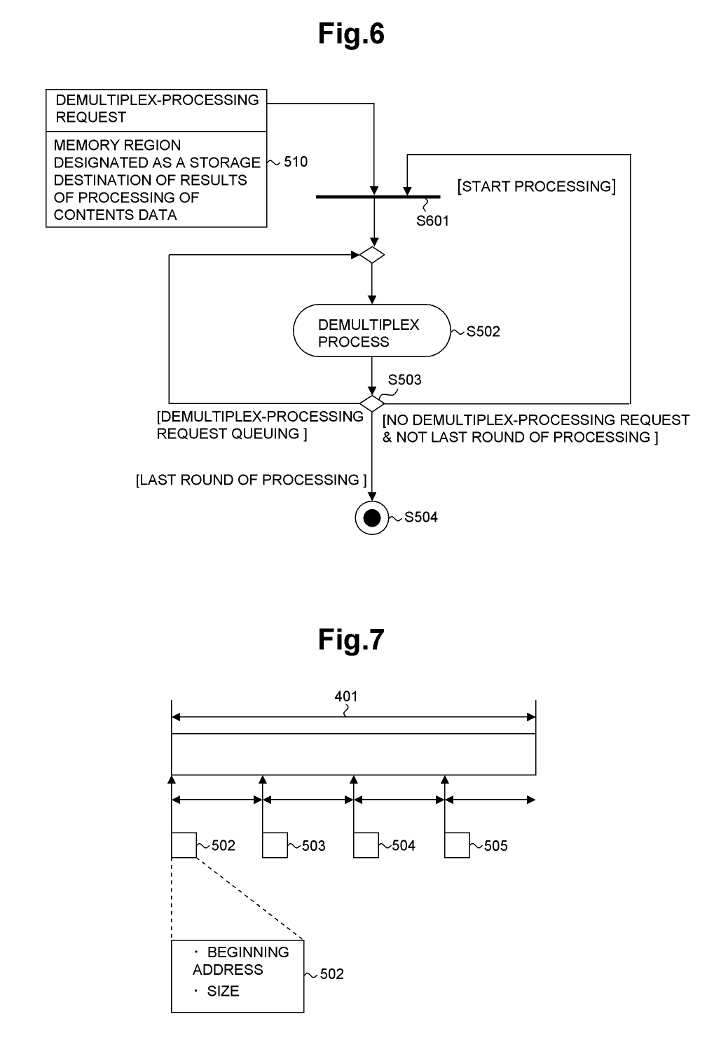

Now, the flow of the demultiplex process shown with reference to FIG. 5 will be described in detail with reference to FIG. 6.

FIG. 6 is a diagram for explaining the flow of the demultiplex process, to which the method for assigning a fixed-size memory region for each processing is applied.

As shown in FIG. 6, after contents data 116 are read out by data-read process 301 first, CPU 101 issues a demultiplex-processing request 610 containing the contents data 116 thus read out, and data indicating a memory region as a storage destination of results of processing, to the demultiplex-processing block 103. On receipt of the processing request 610, the demultiplex-processing block 103 queues the processing request 610 in a buffer provided in the memory region of the memory block 102. Then, the demultiplex-processing block 103 first starts with the processing involved with the processing request subjected to the earliest queuing (S601), refers to data contained in the processing request 610 and specifying a memory region designated as a storage designation to store video ES data resulting from the demultiplex process in, and stores the video ES data in the designated memory region (S 602). After that, the demultiplex-processing block 103 makes a judgment on whether or not a subsequent processing request 610 has been queued in the buffer (S603). If the subsequent processing request 610 has been queued, the demultiplex-processing block 103 executes the processing associated with the subsequent processing request 610.

On the other hand, in case that the processing request which has triggered the process execution in Step 602 indicates the last round of processing, the demultiplex-processing block 103 terminates the demultiplex process (S604). However, in case that at the judgment of Step 603, no processing request is queued in the buffer, and the processing conducted in Step 602 is not the last round of processing, the demultiplex-processing block 103 returns back to Step 601, and stays on standby until a next processing request is issued.

In the above-described demultiplex process, even after contents data to be associated with processing requests have been read out and stored in the buffer, CPU 101 never issues the processing requests as long as memory regions for storing the results of processing in question are not reserved. Therefore, if CPU 101 will issue the processing request more than once, CPU 101 must reserve memory regions corresponding in number to the issued processing requests in advance. For instance, if CPU 101 will issue four processing request, it must reserve the memory regions 402 to 405 as shown in FIG. 4 in advance. In addition, after the demultiplex-processing block 103 stores results of processing for each processing request in a memory region, which is reserved for each processing request, a situation where the actually used memory regions 501 and 502 are smaller in size than the memory regions 402 and 403, as shown in FIG. 5 arises. This is because the sizes of memory regions assigned on an individual processing request basis are determined based on the maximum output data size of the demultiplex process, as already described. Hence, as to the method taken as a comparative example, unused memory regions will arise unless situations where data of results of processing have the maximum output data size arise successively, or unless demultiplex-processing requests for contents data which had a high bit rate at the time of recording are issued successively.

### <<A Method for Assigning a Memory Region According to an Embodiment of the Invention>>

In view of the circumstances, a method for dynamically changing a memory region to be assigned by means of a descriptor for assigning a memory region is adopted for the data processing system 10 according to an embodiment of the invention, instead of the method for assigning a fixed-size memory region to each processing request as described with reference to FIG. 4. Specifically, CPU 101 provides the CPU-controlled block with a processing request with the descriptor attached thereto. Then, based on results of processing executed by the CPU-controlled block, CPU 101 updates the descriptor to attach to the subsequent processing request and thereby changes a memory region to be assigned.

The description below covers, as an example, an application of the method for assigning a memory region to the creation of video ES data in the demultiplex process.

FIG. 7 is a diagram for explaining the descriptor.

In the drawing, the reference numerals 702 to 705 denote descriptors which CPU 101 attaches to processing requests in GOP units during the demultiplex process.

The descriptors 702 to 705 include data of the beginning addresses and sizes of available memory regions for processing to be executed in response to the processing requests which the descriptors are associated with. It is noted that the descriptors 702 to 705 may include other data except the beginning address and its size. However, whether or not to so arrange the descriptors depends on details of the processes in the data processing system 10.

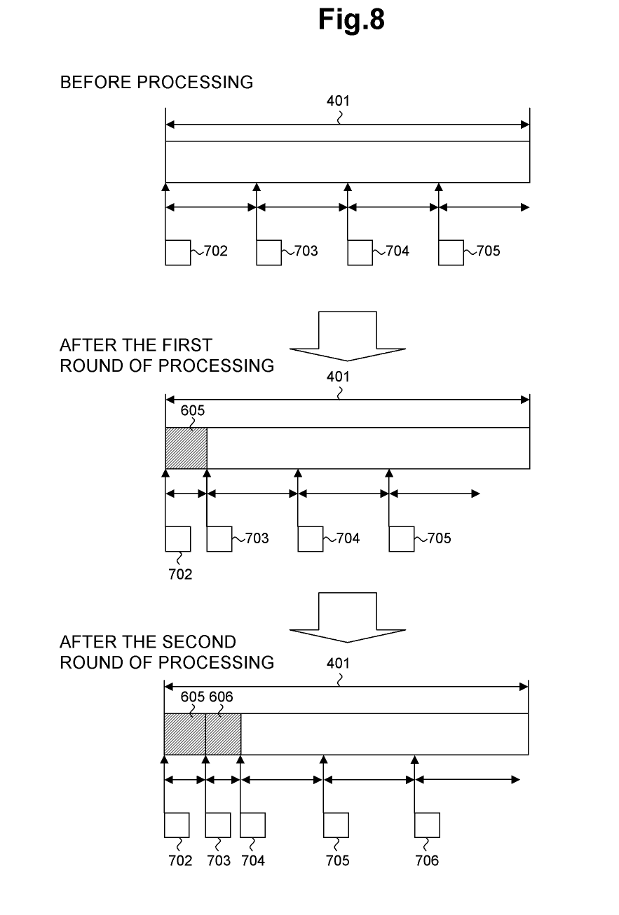

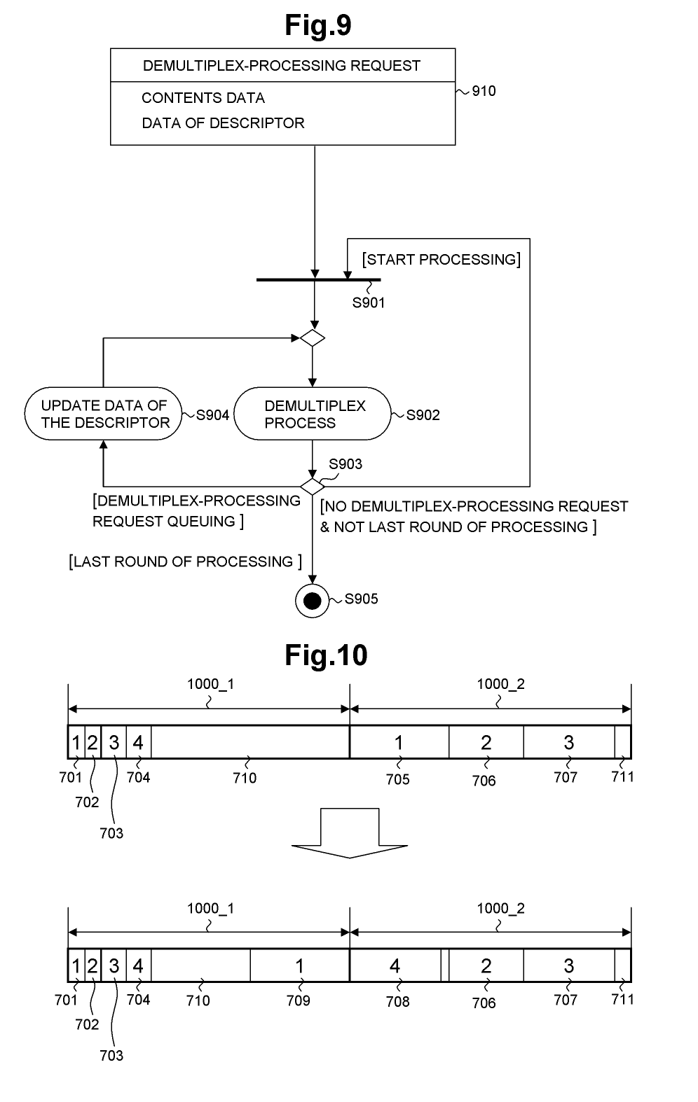

Next, the method for assigning a memory region using a descriptor will be described in detail with reference to FIGS. 8 and 9.

FIG. 8 is a diagram for explaining the method for assigning a memory region using a descriptor.

FIG. 9 is a diagram showing the flow of the demultiplex process to which the method for assigning a memory region using a descriptor is applied.

In FIG. 8, the reference numeral 401 denotes a memory region assigned to the demultiplex process as in FIG. 7. The memory region 401 is segmented into four regions for four times of processing conducted in response to four processing requests; the processing requests are issued in GOP units during the demultiplex process, and attached with the descriptors 702 to 705. The procedure the demultiplex-processing block 103 follows to store results of processing using the beginning address of the memory region 401 as a starting point in this condition will be described with reference to FIG. 9.

As shown in FIG. 9, when directing the demultiplex-processing block 103 to conduct the demultiplex process, CPU 101 issues a processing request 910 containing contents data 116 read out in the data-read process 301, and a descriptor to the demultiplex-processing block 103 on an individual processing request basis. The two kinds of data of the descriptor 702 which the processing request contains are set as follows.

The value of the beginning address of the memory region 401 is set as the data of the beginning address of the descriptor 702. As the data of the size of the available memory region of the descriptor 702, e.g. the value of the maximum output data size calculated from specifications of the product or specifications of compressed data format is set. The reason why the settings as described above are made is that the size of data resulting from the demultiplex process cannot be determined in advance, and therefore the size of data of results of processing is assumed to be the maximum output data size as described above.

The two kinds of data of the descriptor 703 of the subsequent processing request are set as follows.

The beginning address data of the descriptor 703 is set based on the beginning address value of the descriptor 702, and the value of the size of the available memory region. For example, the beginning address data of the descriptor 703 is set to the value of the beginning address of a memory region contiguous to the memory region starting with the beginning address of the descriptor 702, which makes the starting point of the region, and extending to a distance of the available size. The size data of an available memory region of the descriptor 703 is set to the value of the maximum output data size for the same reason as that in the case of the descriptor 702.

The two kinds of data of the descriptors 704 and 705 are set in the same way as those of the descriptor 703.

On receipt of a processing request 910 including a descriptor set in the way as described above, the demultiplex-processing block 103 queues the processing request 910 in a buffer provided in the memory block 102. The demultiplex-processing block 103 responds to the queued processing requests to perform the demultiplex-process starting with the processing associated with the first queued processing request in the order in which the processing requests have been queued (S901). The demultiplex-processing block 103 stores results of the demultiplex process in memory regions based on the data of the descriptors (S902). In the example as shown in FIG. 8, the demultiplex-processing block 103 executes the demultiplex process in response to the processing request involving the descriptor 702, and stores video ES data resulting from the processing in the memory region 805. Then, the demultiplex-processing block 103 notifies CPU 101 of the completion of the processing in response to the processing request, and the value of an address indicating the memory region 805 subjected to the data storing. On receipt of the notification, CPU 101 changes the value of the size of the available memory region of the descriptor 702 involved in the processing request, to which the demultiplex-processing block 103 has already responded thereby to complete the requested operation, to the value of the size of the memory region 805, and confirms whether or not the subsequent processing request has been queued in the buffer (S903). If it is judged in this step that the subsequent processing request has been queued, CPU 101 updates the beginning address data included in the descriptor attached to the subsequent processing request (S904). Specifically, as shown in FIG. 8, CPU 101 changes the beginning address data of the descriptor 703 to the value of the memory address of a next memory region contiguous to the memory region 805 where the resultant data have been stored. Then, CPU 101 sets the beginning address data of the subsequent descriptors 704 and 705 based on the value of the beginning address of the descriptor 703 after the change in the same way as described above. However, at the update, the size data of the descriptors 703 to 705 are not updated. The reason for this is that the data sizes of results of the demultiplex process cannot be determined at the update as already described.

After the data of the descriptors 702 to 705 have been updated according to the above procedure, the demultiplex-processing block 103 executes the demultiplex process in response to the processing request involving the descriptor 703, and stores results of the processing in the memory region 806 based on the data of the descriptor 703 (S902). Then, the demultiplex-processing block 103 notifies CPU 101 of the completion of the processing in response to the processing request, and the value of an address indicating the memory region 806 subjected to the data storing. On receipt of the notification, CPU 101 changes the value of the size of the available memory region of the descriptor 703 involved in the processing request, to which the demultiplex-processing block 103 has already responded thereby to complete the requested operation, to the value of the size of the memory region 806, and confirms whether or not the subsequent processing request has been queued in the buffer (S903). If it is judged in this step that the subsequent processing request has been queued, CPU 101 updates the beginning address data included in the descriptor attached to the subsequent processing request as described above (S904). Specifically, as shown in FIG. 8, CPU 101 changes the beginning address data of the descriptor 704 to the value of the memory address of a next memory region contiguous to the memory region 806 where the resultant data have been stored. Then, CPU 101 sets the beginning address data of the subsequent descriptors 705 and 706 based on the value of the beginning address of the descriptor 704 after the change in the same way as described above. After that, the above steps are repeated as long as a processing request remains queued in the buffer (S902-S904).

On the other hand, in case that the processing request which has triggered the process execution in Step 902 indicates the last round of processing, the demultiplex-processing block 103 terminates the demultiplex process under the control of CPU 101 (S905). In addition, if it is judged in Step 903 that no processing request has been queued in the buffer, and the process executed in Step 902 is not the last one, the demultiplex-processing block 103 returns to Step 901, and waits for a subsequent processing request to be issued. Now, it is noted that in the demultiplex process, CPU 101 issues a processing request after having reserved a memory region making a storage destination of results of processing, and therefore the demultiplex-processing block 103 is not required to wait for a memory region to be released after the start of the demultiplex process for the purpose of reserving an unoccupied memory region.

As described above, in the method for assigning a memory region according to the embodiment, the range of an available memory region for each processing request is updated using a descriptor appropriately. As a result, it becomes possible to reserve a memory region used as a buffer efficiently and to make good use thereof. For example, in the case as shown in FIG. 8, only the memory regions for four processing requests could be reserved in the memory region 401 heretofore. However, the method for assigning a memory region according the embodiment makes it possible to assign memory regions in the memory region 401 to more than four processing requests.

In addition, the method for assigning a memory region can increase the stability of the data processing system 10. For example, even if the hang-up of the demultiplex process occurs in the course of reproduction of stream data, the reproduction can be continued using data stored in the buffer. Therefore, in such a case, a situation that the reproduction is stopped before the system is restored is less prone to be caused.

### <<Temporary Assignment of an Unoccupied Memory Region to Other Process>>

As described above, with the method for assigning a memory region using a descriptor, there is a high probability that an unoccupied memory region is produced in a memory region assigned for each of the demultiplex process, audio decode process and the like. However, in such a case, it is possible to temporarily assign an unoccupied memory region for another process.

FIG. 10 is a diagram for explaining an example of a method for using an unoccupied memory region effectively in a system such that the reproduction and recording of contents data are performed in parallel.

The description here is presented taking, as examples, the memory region 1000_1 for storing video ES data, which is one of memory regions assigned for reproduction, and memory region 1000_2 for storing TS (Transport Stream) data multiplexed for recording, which is one of memory regions assigned for the storing.

In FIG. 10, the reproduction and storing are conducted in response to up to four processing requests. In the memory region 1000_1 for storing video ES data, video ES data resulting from the execution of processing in response to four processing requests are stored, whereas in the memory region 1000_2 for storing TS data, TS data resulting from the execution of processing in response to three processing requests are stored. Now, it is noted that in FIG. 10, the numerals which the inside portions of the memory regions 1001 to 1009 are labeled with mean the order in which data are stored. For example, the memory region 1005 in the memory region 1000_2 for storing TS data is a region where results of the first round of processing are stored during the storing, and the memory region 1007 is a region where result of the third round of processing are stored during the storing.

As shown in FIG. 10, the memory region 1000_1 for storing video ES data has still an unoccupied memory region 1010 therein, and has a large room which can be used as a memory region even though the number of processing requests, for which reproduction has been completed, is the upper limit of the number of acceptable processing requests, namely four. In contrast, with the memory region 1000_2 for storing TS data, the processing in response to the last processing request can be executed. However, the memory region 1000_2 has only an unoccupied memory region denoted by the reference numeral 1011, and does not have enough room therein. In case that a record processing request is issued under the condition, a part of an unoccupied memory region of the memory region 1000_1 for storing video ES data can be temporarily assigned as a buffer for the requested storing process. Specifically, the following steps are performed: moving results of the first round of processing stored in the memory region 1005 into the memory region 1009; and using the memory region 1005 emptied out as a result of the move to store results of the fourth round of processing in the memory region 1008. The reason why the steps are executed is that the room remaining in the memory region 1000_1 for storing video ES data is just a temporarily arising one, and therefore the system can run out of a memory region required for the next round of reproduction.

To temporarily assign an unused memory region for another process, the method for moving existing data as described above may be used for the purpose of shortening the time a memory region to be temporarily used is occupied. Otherwise, if it is expected that it will take a long time to move existing data, a method for directly storing results of the fourth round of processing in the unused memory region may be adopted. Further, in view of a memory usage and other condition under a predetermined situation, the way for dynamically changing the method for using an unused memory region may be adopted. As described above, a concrete method for temporarily assigning an unused memory region cannot be determined stereotypically, and it should be changed depending on the performance of an entire system and its design policy.

### <<First-In, First-Out Assignment of Memory Regions>>

The above-described method for assigning a memory region using the descriptor is useful in application to a system such that CPU 101 issues a processing request after reserving a memory region for storing results of processing, whereas the method for assigning a memory region described below is useful in application to a system such that CPU 101 issues a processing request without reserving a memory region for storing results of processing.

As an example of the method, a method for assigning a memory region according to another embodiment of the invention will be described here, by which results of processing are held in a memory region for each processing request in the first-in, first-out mode, using a first pointer indicating the address of a memory region for storing results of processing conducted by the CPU-controlled block in response to a processing request, and a second pointer showing the address of a memory region, which has been released by reading the results of processing from the memory region with the results of processing stored therein.

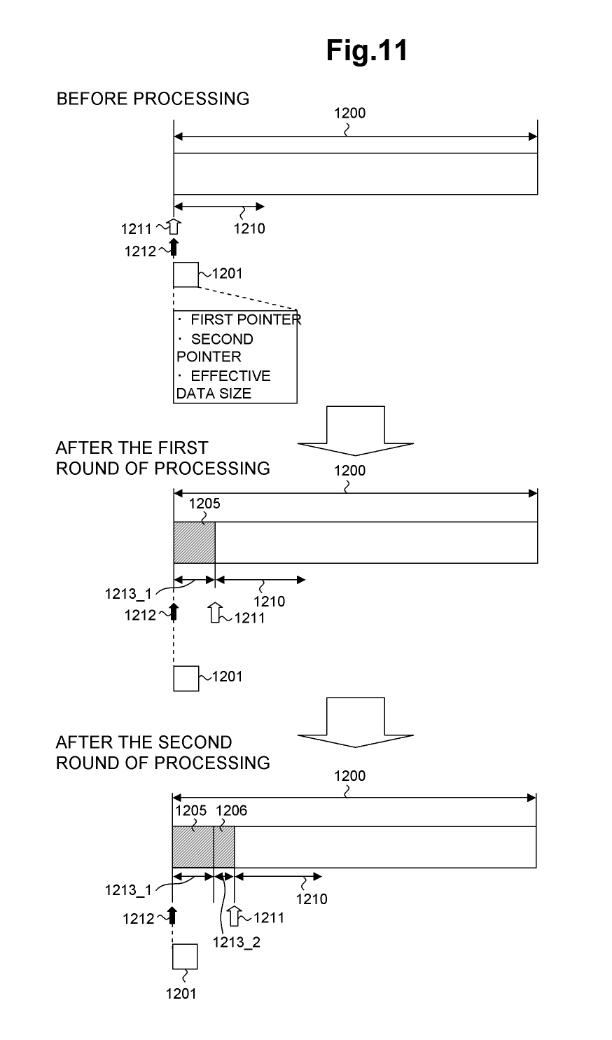

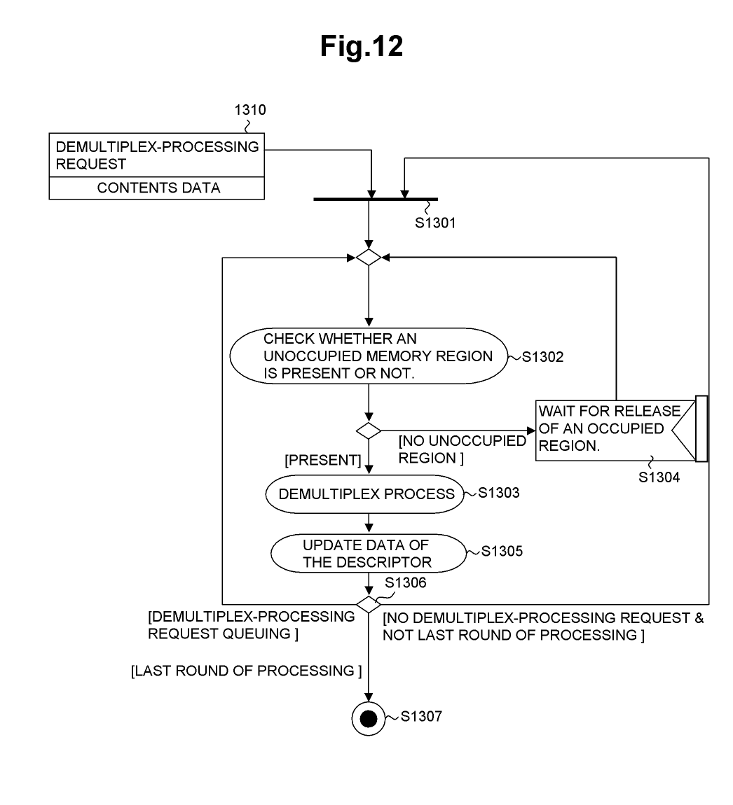

An application of the method for storing results of processing according to the embodiment to a data processing system such that CPU 101 issues a processing request without reserving a memory region for storing results of processing will be described in detail with reference to FIGS. 11 and 12.

FIG. 11 is a diagram for explaining a method for storing data using a descriptor.

FIG. 12 is a diagram showing the flow of the demultiplex process to which the method for storing data using a descriptor is applied.

The description below is presented taking, as an example, the process for outputting video ES data involved in the demultiplex process—one of processes executed in the data processing system 10.

In FIG. 11, the reference numeral 1200 denotes a memory region which has been assigned for the demultiplex process in advance. The memory region 1200 is addressed based on a descriptor 1201.

The descriptor 1201 is a descriptor for managing the memory region 1200, which includes three forms of data. The first form of data consists of a first pointer (hereinafter referred to as “write pointer”) 1211 which indicates an address of a memory region to store results of processing in response to a new processing request in. For example, it indicates an address at which the writing of new results of processing is started. The second form of data consists of a second pointer (hereinafter referred to as “read pointer”) 1212 which indicates an end address of a memory region released by reading results of processing therefrom. For example, it indicates an address at which the reading of results of processing is started. The third form of data consists of an effective data size which shows the size of a memory region with effective results of processing held therein.

The three forms of data of the descriptor 1201 are stored in e.g. registers respectively, and the values thereof are updated by CPU 101 each time the processing in response to a processing request is completed.

As shown in FIG. 11, the write pointer 1211 and read pointer 1212 indicate the beginning address of the memory region 1200. On condition that the effective size data is zero initially, the procedure for storing results of the demultiplex process will be described with reference to FIG. 12.

In the example shown in FIG. 12, when directing the demultiplex-processing block 103 to conduct the demultiplex process first, CPU 101 issues a processing request 1310, which includes contents data 116 read out by the data-read process 301, to the demultiplex-processing block 103. The demultiplex-processing block 103 queues the processing request 1310 in a buffer provided in the memory block 102. In handling the processing requests queued in this way, the demultiplex-processing block 103 starts with processing involved with the processing request subjected to the earliest queuing (S1301). After starting the processing, the demultiplex-processing block 103 refers to the descriptor 1201 and checks whether or not an unoccupied memory region extending from an address indicated by the write pointer 1211 to the size 1210 required for storing results of processing is present (S1302). The judgment on the presence or absence of an unoccupied memory region is performed based on the values of addresses which the write pointer 1211 and read pointer 1212 indicate. For example, the demultiplex-processing block 103 determines the difference between the end address of the memory region 1200 and the address indicated by the write pointer 1211 thereby to calculate the size of an unoccupied memory region. Then, the demultiplex-processing block 103 compares the unoccupied memory region size thus calculated with the required size 1210, thereby to make a judgment on whether or not an unoccupied memory region with the required size is present. The required size 1210 refers to e.g. the maximum output data size calculated from specifications of the product or specifications of compressed data format, and it may be stored as the fourth form of data of the descriptor 1201, or may be stored in a register separately prepared or the like.

If it is judged in Step 1302 that an unoccupied memory region having the required size 1210 is absent, the demultiplex-processing block 103 notifies CPU 101 of the absence, and waits for a memory region to be released (S1304). In the example shown in FIG. 11, an unoccupied memory region having the required size 1210 is present. Therefore, the demultiplex-processing block 103 executes the demultiplex process, and stores the video ES data resulting from the processing in the memory region 1205 (S1303). Then, the demultiplex-processing block 103 notifies CPU 101 of the completion of the processing in response to the processing request, and the value of an address indicating the memory region subjected to the data storing. On receipt of the notification, CPU 101 updates the values of the descriptor 1201 (S1305). Specifically, CPU 101 changes the value of the effective data size to the value of the size 1213_1 of the memory region 1205 where the results of processing are stored, and the write pointer 1211 to the value of the memory address of a memory region contiguous to the memory region 1205. After that, the demultiplex-processing block 103 checks whether or not the subsequent processing request has been queued in the buffer (S1306). If the subsequent processing request has been queued, the demultiplex-processing block 103 refers to the descriptor 1201, and checks whether or not a memory region extending from the address indicated by the write pointer 1211 to the size 1210 required for storing results of processing is present in order to execute the processing involved with the processing request subjected to the earliest queuing, as described above (S1302). In the example shown in FIG. 11, an unoccupied memory region having the required size 1210 is present, and therefore the demultiplex-processing block 103 executes the demultiplex process, and stores the resultant video ES data in the memory region 1206 (S1303). Then, the demultiplex-processing block 103 notifies CPU 101 of the completion of the processing in response to one processing request, and the value of an address indicating the memory region where the data are stored. On receipt of the notification, CPU 101 updates the values of the descriptor 1201 (S1305). Specifically, CPU 101 changes the value of the effective data size to the value of the sum of the size 1213_1 of the memory region 1205 where the results of the preceding processing are stored, and the size 1213_2 of the memory region 1206 where the results of the latest processing are stored. That is, the data of the effective data size is made the value of the total size of the effective data stored in the memory region 1200. Also, CPU 101 changes the write pointer 1211 to the value of the memory address of a memory region contiguous to the memory region 1206.

In case that the processing request which has triggered the process execution in Step 1303 indicates the last round of processing, CPU 101 updates the values of the descriptor 1201 in Step 1305, and controls the demultiplex-processing block 103 to terminate the demultiplex process (S1307). In Step 1306, if no processing request has been queued in the buffer, and the processing executed in Step 1303 is not the last round of processing, the demultiplex-processing block 103 returns back to Step 1301, and waits for a next processing request to be issued.

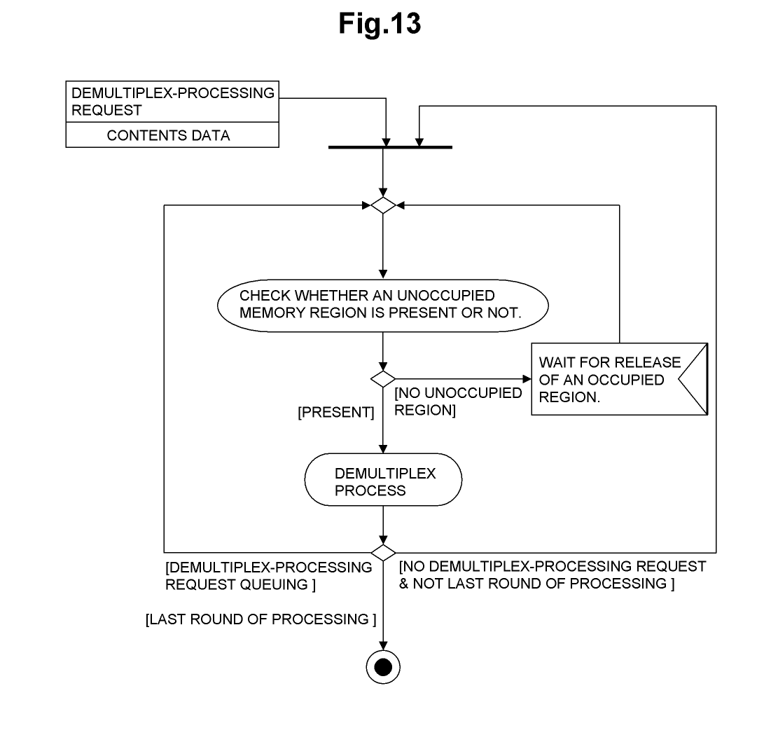

The method for storing data successively using a fixed-size memory region instead of using the descriptor 1201 will be described with reference to FIG. 13, as a comparative example.

FIG. 13 is a diagram for explaining the flow of the demultiplex process to which the method for storing data using a fixed-size memory region is applied.

In the case of the data-storing method described with reference to FIG. 13, the descriptor 1201 is not used, and therefore, the data-storing method does not include the step of updating descriptor data.

According to the data-storing method described with reference to FIG. 13, the demultiplex-processing block 103 checks the presence or absence of an unoccupied memory region having a fixed size for each processing request, and if such unoccupied memory region is present, stores data on an individual fixed-size memory region basis. Therefore, it is possible to use fixed-size memory regions one by one. However, with this method, an unused memory region as shown in FIG. 5 can develop and the memory region cannot be used effectively, as in the case of the forementioned method characterized by assigning a fixed-size memory region to a unit of processing in advance.

In contrast, in the case of the method for storing data using the descriptor 1201 according to the embodiment of the invention, CPU 101 updates data of the descriptor 1201 each time the demultiplex-processing block 103 completes the processing in response to a processing request, and therefore the demultiplex-processing block 103 can successively store results of processing in contiguous memory regions. Consequently, the memory region 1200 can be used effectively.

### <<Method for Reading Data Using the Descriptor 1201>>

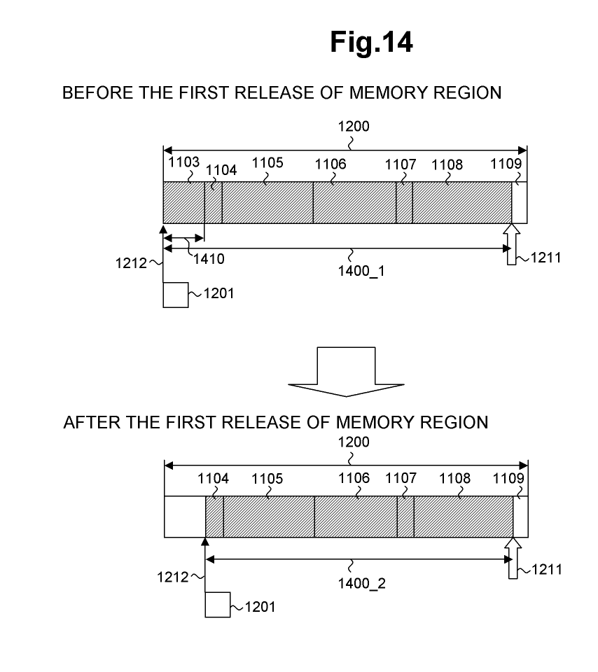

The method for reading results of processing using the descriptor 1201 will be described with reference to FIG. 14.

FIG. 14 is a diagram for explaining the method for reading data using the descriptor 1201.

In FIG. 14, the reference numeral 1200 denotes a memory region assigned for storing video ES data resulting from the demultiplex process, as in the drawing referred to in the description on the method for storing data according to the embodiment of the invention.

Referring to FIG. 14, data have been stored in the memory region 1200 from thebeginningaddress sequentially by the method for storing data using the descriptor 1201, which has been described above, and effective data are placed in the area extending from the memory region 1403 to the memory region 1408. In this condition, three forms of data of the descriptor 1201 are as follows. The data of the effective data size is the value 1400_1 of the total size of memory regions with effective data stored therein. The write pointer 1211 indicates the beginning address of the memory regions 1409 contiguous to the memory region 1408. The read pointer 1212 indicates the beginning address of the memory region 1200.

Now, the procedure which the video decoder section 106 follows to read video ES data necessary for a decode process in this condition will be described. The operation of data read is started with effective data stored in the memory region 1200 at the earliest time, and successively performed. In other words, the video decoder section 106 reads data of the size 1410, which the decoder section is requested to read, from the address designated by the read pointer 1212. Specifically, in the condition shown in FIG. 14, the video decoder section 106 refers to the descriptor 1201 to check the memory region 1200 for effective data stored therein from the value of the effective data size. If the memory region 1200 has effective data stored therein, the video decoder section 106 reads data of the requested size 1410 based on the read pointer 1212. In this example, data in the memory region 1403 are read out, and then the memory region 1403 is released. After having finished reading the data with the requested size 1410, the video decoder section 106 notifies CPU 101 of the completion of the data reading, and the address of the memory region subjected to the data reading. On receipt of the notification, CPU 101 updates data of the descriptor 1201. Specifically, CPU 101 changes the data of the effective data size from the value 1400_1 before the update to the value 1400_2 resulting from the subtraction of the size 1410 of the read data from the value 1400_1. In addition, CPU 101 changes data of the read pointer 1212 to the beginning address of the memory region 1404 contiguous to the memory region 1403 subjected to the data release. Then, the operation of data read is finished.

### <<Data Storing Method Based on the Wrap-Around Technique>>

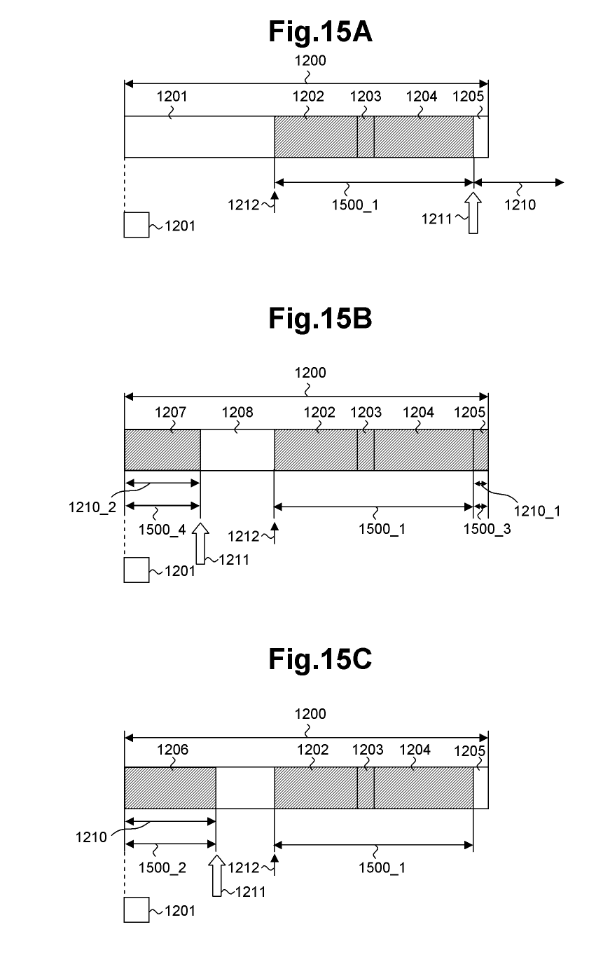

Next, a method for storing data using the descriptor 1201 based on the wrap-around technique will be described with reference to FIGS. 15A to 15C.

FIG. 15A is a diagram for explaining the demultiplex process according to the data-storing method based on the wrap-around technique.

In the example shown in FIG. 15A, the memory region 1501 has been released as a result of data read therefrom, and effective data are stored in the area extending from the memory region 1502 to the memory region 1504. In this condition, the three forms of data of the descriptor 1201 are as follows. The data of the effective data size is the value 1500_1 of the total size of memory regions with effective data stored therein. The write pointer 1211 indicates the beginning address of the memory region 1505 contiguous to the memory region 1504. The read pointer 1212 indicates the beginning address of the memory region 1502. In this case, the memory region 1505 is an unoccupied memory region determined from on the difference between the end address of the memory region 1200 and the address designated by the write pointer 1211, and its size is smaller than the size 1210 of the memory region required for storing results of processing in response to the subsequent processing request.

The following two data-storing methods can be cited as examples of the data-storing method based on the wrap-around technique applicable to the case as shown in FIG. 15A.

The first data-storing method is a data-storing method by which the action of storing data wraps around at the end address of the memory region 1200.

FIG. 15B is a diagram for explaining the first data-storing method based on the wrap-around technique.

FIG. 15A shows a condition before storing data according to the wrap-around technique. In this condition, on receipt of a processing request for a new demultiplex process, the demultiplex-processing block 103 uses the descriptor 1201 to check the presence or absence of an unoccupied memory region with a required size 1210 for storing results of processing, as described above. As a consequence, if no unoccupied memory region is present, the demultiplex-processing block 103 goes standby as described above. In contrast, if an unoccupied memory region is present, and the size of the unoccupied memory region 1505 is larger than the required size 1210, the demultiplex-processing block 103 stores the results of processing by the method as described above with reference to FIG. 11. However, if an unoccupied memory region is present, and the size of the memory region 1505 is smaller than the required size 1210, the demultiplex-processing block 103 stores data to the end address of the memory region 1200 based on the write pointer 1211, and then wraps around at the end address to continue storing the remaining data in the memory region 1200 from the beginning address thereof. After the completion of data storing, the demultiplex-processing block 103 notifies CPU 101 of the completion of the data storing and the address of the memory region subjected to the data storing as already described above. Then, CPU 101 updates the descriptor 1201 on receipt of the notification. Specifically, as shown in FIG. 15B, CPU 101 shifts the write pointer 1211 to the value of the beginning address of the memory region 1508 contiguous to the memory region 1507. Also, CPU 101 changes the data of the effective data size to the total value of the size 1500_1 of the memory region where effective data have been stored in advance, and the size 1500_3 of the memory region 1505 and the size 1500_4 of the memory region 1507, where data resulting from the latest processing in question have been stored.

The first data-storing method enables the wrap-around control from the beginning address of the memory region 1200 to the end address, and thus the memory region 1200 can be used with economy.

Next, the second data-storing method based on the wrap-around technique will be described.

The second data-storing method is a data-storing method by which the action of storing data is made to wrap around depending on the size of an unoccupied memory region.

FIG. 15C is a diagram for explaining the second data-storing method based on the wrap-around technique.

Ina condition before data storing base on the wrap-around technique as shown in FIG. 15A, on receipt of a new processing request for the demultiplex process, the demultiplex-processing block 103 checks the presence or absence of an unoccupied memory region having a required size 1210 in order to store results of processing using a descriptor in the same way as described above. In this step, if the size of the memory region 1505 is larger than the required size 1210, the demultiplex-processing block 103 performs the same processing as in the case of the first data-storing method. In contrast, if the size of the unoccupied memory region 1505 is smaller than the required size 1210, the demultiplex-processing block 103 makes a judgment on whether or not an unoccupied memory region is present in the memory region 1200, which starts with the beginning address of the memory region 1200. Then, if the size of the memory region 1501 extending from the beginning address of the memory region 1200 to the address indicated by the read pointer 1212 is smaller than the required size 1210, the demultiplex-processing block 103 goes standby as already described. However, if the size of the memory region 1501 is larger than the required size 1210, the demultiplex-processing block 103 wraps around, and stores results of processing in a memory region extending from the beginning address. After the completion of data storing, the demultiplex-processing block 103 notifies CPU 101 of the completion of the data storing and the address of the memory region subjected to the data storing, as performed at the completion of the above-described process. Then, CPU 101 updates the descriptor 1201 on receipt of the notification. Specifically, as shown in FIG. 15C, CPU 101 changes the data of the write pointer 1211 to the value of the memory address of a next memory region contiguous to the memory region 1506. Also, CPU 101 changes the data of the effective data size to the total value of: the total size 1500_1 of the memory region where effective data have been stored in advance; and the size 1500_2 of the memory region 1506, where data resulting from the latest processing in question have been stored.

According to the second data-storing method, the wrap-around control is performed based on the size of an unoccupied memory region ranging from the write pointer 1211 to the end address of the memory region 1200 in storing results of processing. Therefore, results of processing can be stored in contiguous memory regions in units of processing.

### <<Data Reading Method Based on the Wrap-Around Technique>>

A method for reading data stored after the wraparound by the first data-storing method will be described here.

The data reading method of interest follows the steps of: reading data put in the memory region 1200 between the address indicated by the read pointer 1212 and the end address of the memory region, based on the pointer; and after reading the data in the memory region up to the end address, warping up, and then reading data in the memory region 1200 from the beginning address thereof.

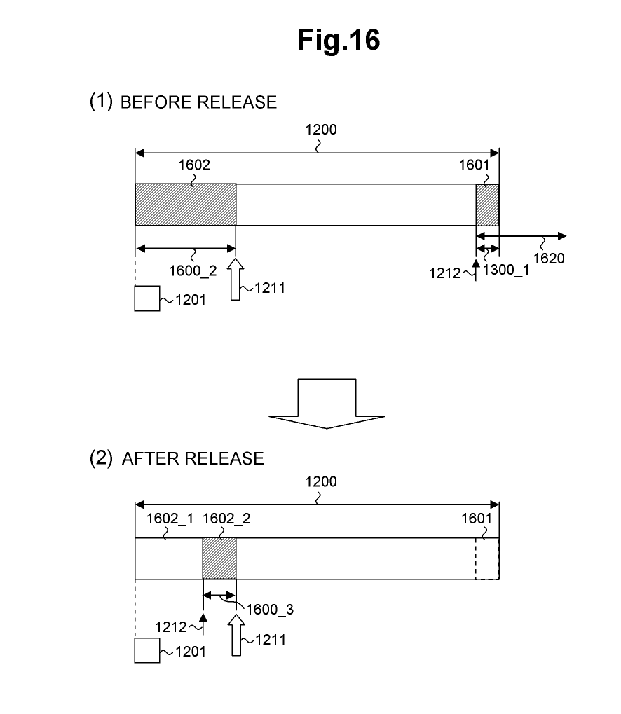

Now, an example of the data reading method will be described with reference to FIG. 16.

More specifically, FIG. 16 is for describing an example of the data reading method arranged to fit the first data-storing method.

In the example shown by FIG. 16, video ES data resulting from the demultiplex process have been stored in memory regions 1601 and 1602 of the memory region 1200, and the effective data size is the total size of the data size 1600_1 of the memory region 1601, and the data size 1600_2 of the memory region 1602. The write pointer 1211 indicates the beginning address of a memory region contiguous to the memory region 1601, and the read pointer 1212 indicates the beginning address of the memory region 1601.

Now, the procedure which the video decoder section 106 follows to read the stored video ES data in this condition will be described below.

In the example shown by FIG. 16, the video decoder section 106 uses the descriptor 1201 to start a process of reading data having a size requested by a data read request, as in the case of the method described with reference to FIG. 14. Then, after having finished data read out of the memory region 1200 up to the end address thereof, the video decoder section 106 warps around, and reads the remaining data from the beginning address of the memory region 1200. After the completion of the reading of data having the size requested by the data read request, the video decoder section 106 notifies CPU 101 of the completion of the data reading and the address of the memory region subjected to the data reading, as performed at the completion of the above-described process. Then, CPU 101 updates the descriptor 1201 on receipt of the notification. Specifically, as shown in FIG. 16, CPU 101 shifts the read pointer 1212 to the beginning address of the memory region 1602_2 contiguous to the memory region 1602_1. Also, CPU 101 changes the data of the effective data size to the size 1600_3 derived by subtracting sizes of the memory regions 1601 and 1602_1, which are released by the read processing from the total of the sizes 1600_1 and 1600_2 of memory regions with the data previously stored therein.

According to the method as described above, the video decoder section wraps around and again starts reading data from the beginning address of the memory region 1200 after reading data until reaching the end address of the memory region. Therefore, it is possible to read all the effective data stored in the memory region.

Next, a method for reading data which have been stored according to the second data-storing method will be described.

In the case of data storage according to the second data-storing method, data could not be stored in the memory region 1200 until the end address of the region is reached. In such case, the data reading method is a method which follows the steps of: reading data until an address to which effective data have been stored in the memory region is reached; wrapping around; and again reading data in the memory region 1200 from the beginning address thereof.

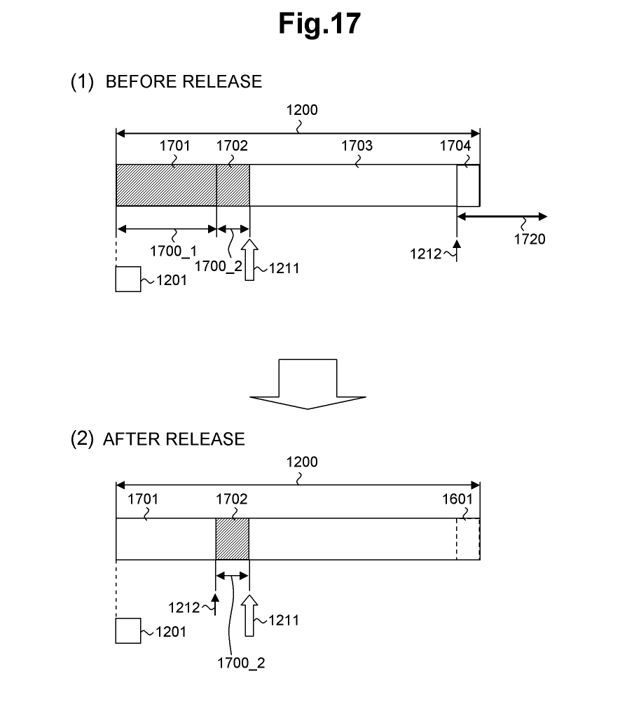

An example of such reading method will be described with reference to FIG. 17.

More specifically, FIG. 17 is for explaining an example of the method for reading data stored according to the second data-storing method.

As shown in FIG. 17, the video ES data resulting from the demultiplex process have been stored in the memory regions 1701 and 1702 of the memory region 1200. The effective data size is the total of the data size 1700_1 of the memory region 1701 and the data size 1700_2 of the memory region 1702. Further, the write pointer 1211 indicates the beginning address of the memory regions 1703 contiguous to the memory region 1701, and the read pointer 1212 indicates the beginning address of the memory region 1704.

Now, the procedure which the video decoder section 106 follows to read the stored video ES data in this condition will be described.

In the example shown in FIG. 17, when reading data, the video decoder section 106 judges whether or not the size of a memory region determined by the difference between an address indicated by the write pointer 1211 and the beginning address of the memory region 1200 agrees with the effective data size of the descriptor 1201. As a result, if the two data sizes are judged to be in disagreement, the video decoder section 106 reads data according to the method as described with reference to FIG. 14. In contrast, if the two data sizes are judged to be in agreement, the video decoder section 106 wraps around, and reads data of a size 1720 requested by a data read request from the beginning address of the memory region 1200. Then, the video decoder section 106 notifies CPU 101 of the completion of the data reading, and the address of the memory region subjected to the data reading, as performed in reading data stored according to the first data-storing method. Thereafter, CPU 101 updates the data of the descriptor 1201 on receipt of the notification. Specifically, CPU 101 changes the data of the size of effective data to the size 1700_2 of the memory region 1702, and the value of the read pointer 1212 to the beginning address of the memory region 1702.

According to the method, even in a situation where data have not been stored in the memory region 1200 until the end address of the region is reached, the video decoder section 106 wraps around appropriately, and again reads data from the beginning address of the memory region. Therefore, it is possible to read all the effective data stored in the memory region.

Another examples of the data reading method applicable to the case of data stored according to the second data-storing method is a method which follows the steps: registering the address of a memory region which was not used during data storage according to the second data-storing method, and reading data based on the address at the time of data read.

For example, in the example of FIG. 17, the demultiplex-processing block 103 stores data in the memory regions 1701 and 1702 according to the second data-storing method, and thereafter notifies CPU 101 of the above-described items together with the value of the address of the memory region 1704 with no data stored therein. On receipt of the notification, CPU 101 regards the memory region 1704 as an unavailable memory region, and registers the value of the address of the unavailable region in the descriptor 1201. When thereafter reading data, the video decoder section 106 refers to the descriptor 1201, reads data based on the read pointer 1212 until reaching an address before the memory region 1704, wraps around at the address, and then again reads data in the memory region 1200 from the beginning address. After the completion of the data reading, the video decoder section 106 notifies CPU 101 of the completion of the data reading and the address of the memory region subjected to the data reading as already described above. Then, CPU 101 updates the descriptor 1201 on receipt of the notification. In this time, besides the update, CPU 101 clears the registered value of the address of the memory region 1704, thereby to make the memory region 1704 an available memory region.

The data-reading method offers the same effects as the data-reading method cited as the first example of the method for reading data stored according to the second data-storing method achieves.

As described above, a memory region in the memory block 102 can be used effectively by adopting, for the demultiplex process, the method for assigning a memory region according to the embodiment of the invention, and the data-reading method arranged to fit it.

Further, the above description covered application examples of the method for assigning a memory region according to the embodiment of the invention, and the data-reading method arranged to fit it to the demultiplex process. However, the methods are applicable to other processes involved in the reproduction. Even in the applications to the audio decode process and video decode process, for example, the methods can achieve the same effects.

### <<Memory Region Assignment in Recording>>

While the methods for assigning a memory region which have been described above are examples of the application to the reproduction in the data processing system 10, the method for assigning a memory region to be described here is applicable to the recording.

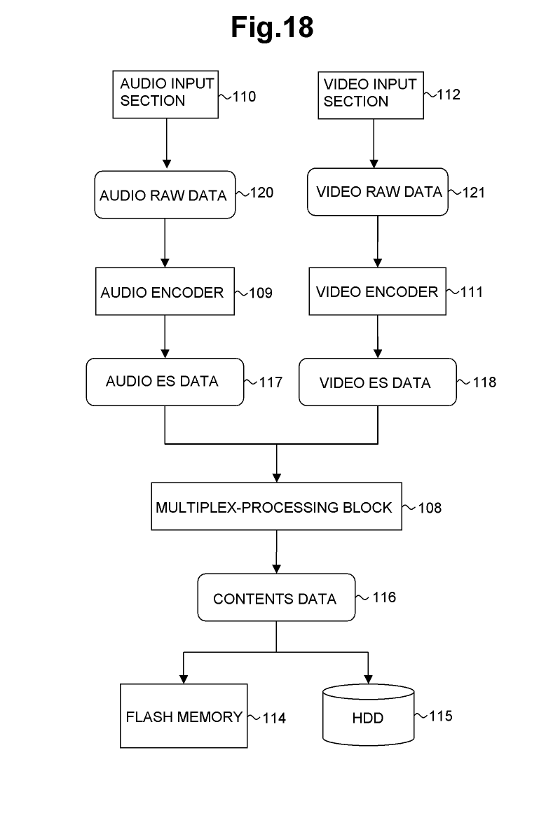

FIG. 18 is a diagram showing the flow of data during the recording.

Data targeted for the recording in FIG. 18 are MPEG-format data, for example.

During the recording, the audio input section 110 converts sounds captured thereinto to electric signals, and outputs as audio Raw data 120. In addition, the video input section 112 converts a video image captured thereinto to electric signals, and outputs as video Raw data 121. The audio Raw data 120 so output are entered into the audio encoder section 109, and subjected to the encode process, and then output as audio ES data 117. Likewise, the video Raw data 121 are entered into the video encoder section 111, subjected to the encode process, and then output as video ES data 118. The multiplex processing block 108 accepts, as inputs, the audio ES data 117 and video ES data 118, and multiplexes these data to produce contents data 116. The contents data 116 thus produced are recorded by the recorder 30. The recording can be conducted in fact by storing the contents data 116 in the flash memory 114 and HDD 115 serving as recording media. A type of data varying depending on the storing format may be prepared separately e.g. in parallel with these processes, or by presetting a parameter.

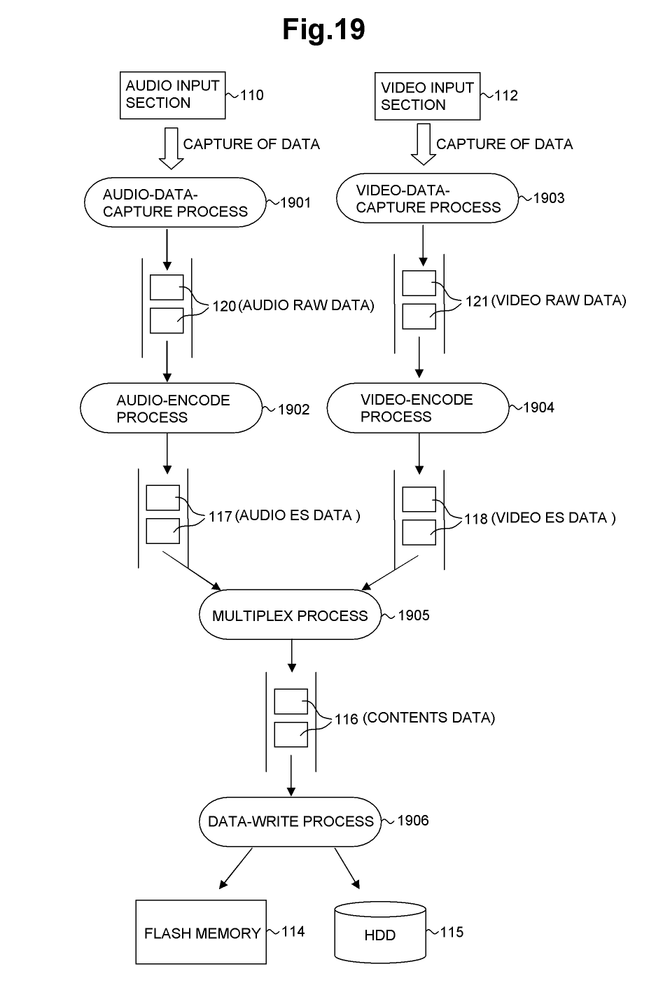

FIG. 19 is a diagram for explaining details of the recording and data connected with it.

In the multiplex process 1905, a series of multiplex processing conducted on one GOP of contents data is treated as the unit of processing thereof. However, the way to define the unit of processing like this is just an example. The unit of processing may be changed depending on e.g. the specifications of hardware which will execute the process, and details of the process to be conducted.

In the recording as shown by FIG. 19, part of the memory region is used as a buffer during the audio-data-capture process 1901, audio-encode process 1902, video-data-capture process 1903, video-encode process 1904, multiplex process 1905 and data-write process 1906, as during the processes involved in the reproduction.

In deciding the size of a memory region assigned as the buffer, the size of the buffer for storing audio Raw data 120 and video Raw data 121, produced by the audio-data-capture process 1901 and video-data-capture process 1903 may be calculated in advance from e.g. specifications of the audio input section 110, and video input section 112. However, it is difficult to previously determine the size of the buffer for storing the audio ES data 117 and video ES data 118 produced by the audio-encode process 1902 and video-encode process 1904. This is because it is difficult to previously calculate to what extends the audio and video Raw data are compressed by the audio-encode process 1902 and video-encode process 1904. Also, it is difficult to previously determine the size of the buffer for storing the contents data 116. The is because data sizes of the audio ES data 117 and video ES data 118 before multiplexing, which are handled in the given units of processing, fluctuate.

Therefore, the method for assigning a memory region and the method for reading data, which have been applied to the reproduction, can be adopted for buffers used during the audio-encode process 1902, video-encode process 1904, and multiplex process 1905, and the same effects can be achieved.

While the invention made by the inventor has been described above based on the embodiments thereof concretely, the invention is not limited to the embodiments. It will be obvious that various changes and modifications may be made without departing from the subject matter thereof.

For example, a means which makes possible to select the method for assigning a fixed-size memory region for each processing request described with reference to FIG. 4 as a comparative example, and the method for assigning a memory region according to the embodiment of the invention in a data processing system comparable in function to the data processing system may be adopted. In this case, storing parameters corresponding the methods for assigning a memory region respectively in registers or other equivalent devices corresponding to the individual CPU-controlled blocks enables CPU 101 to refer to appropriately the registers or other equivalent devices thereby to decide the method for assigning a memory region according to the situation of processing. Otherwise, which assigning method to select may be decided according to the specifications of the system or other factors, in the design phase of the data processing system 10.

What is claimed is:

1. A data processing system comprising:
a memory block for storing data;
a data-processing control block which assigns a memory region of the memory block for storing results of processing of stream data;
a demultiplex-processing block which demultiplexes multiplexed encoded data using the memory region assigned thereto on receipt of each processing request; and
a decode-processing block which decodes the demultiplexed encoded data using the memory region assigned thereto on receipt of each processing request,
wherein the data-processing control block puts at least one of the demultiplex-processing block and decode-processing block under its control, and
the data-processing control block changes a memory region to assign for each processing request based on results of processing conducted by the at least one block in response to a processing request precedent thereto.

2. The data processing system according to claim 1, wherein the data-processing control block attaches a descriptor to each processing request of the at least one block, and
the descriptor is referred to when storing, in a memory region assigned for each processing request, results of processing conducted by the at least one block in response to the processing request.

3. The data processing system according to claim 2, wherein the descriptor includes: data of a beginning address of an available memory region in the memory block; and data which specifies a size of the available memory region.

4. The data processing system according to claim 3, wherein each time the at least one block completes processing to conduct on receipt of each processing request, the data-processing control block changes the beginning address data of the descriptor based on the size of the memory region where results of the completed processing have been stored, and attaches the changed descriptor to a subsequent processing request.

5. The data processing system according to claim 1, wherein the memory block has a descriptor for storing results of processing by the at least one block in a memory region for each processing request,
the descriptor includes: a first pointer indicating an address of a memory region to store results of processing in response to a new processing request in; effective size data showing a size of a memory region with effective results of processing held therein; and a second pointer indicating an address of a memory region which has been released by reading results of processing therefrom, and
the at least one block puts results of processing in response to a processing request in a memory region assigned therefor using the first and second pointers, in a first-in, first-out mode.

6. The data processing system according to claim 5, wherein on condition that a difference between a value of the first pointer and an end address of the memory region is smaller than a required maximum memory size, the at least one block controls its action on the memory region according to a wrap-around technique, and results of processing in response to a new processing request are stored in the memory region from its beginning address.

7. The data processing system according to claim 5, wherein on condition that a difference between a value of the first pointer and an end address of the memory region is smaller than a required maximum memory size, the at least one block controls its action on the memory region according to a wrap-around technique, and
under the control according to the wrap-around technique, results of processing in response to a new processing request are stored according to a value of the first pointer.

8. The data processing system according to claim 6, wherein on condition that the effective size data is equal to the difference between the value of the first pointer and the beginning address of the memory region, the at least one block reads data stored in the memory region from its beginning address when reading results of processing in response to a processing request from the memory region.

9. A data processing system, comprising:
a memory block for storing data;
a data-processing control block which assigns a memory region of the memory block for storing results of processing of stream data;
an encode-processing block which encodes input data using the memory region assigned thereto on receipt of each processing request; and
a multiplex-processing block which multiplexes the encoded data using the memory region assigned thereto on receipt of each processing request,
wherein the data-processing control block puts at least one of the encode-processing block and multiplex-processing block under its control, and
the data-processing control block changes a memory region to assign for each processing request based on results of processing conducted by the at least one block in response to a processing request precedent thereto.

10. The data processing system according to claim 9, wherein the data-processing control block attaches a descriptor to each processing request of the at least one block, and
the descriptor is referred to when storing, in a memory region assigned for each processing request, results of processing conducted by the at least one block in response to the processing request.

11. The data processing system according to claim 9, wherein the memory block has a descriptor for storing results of processing by the at least one block in a memory region for each processing request,
the descriptor includes: a first pointer indicating an address of a memory region to store results of processing in response to a new processing request in; effective size data showing a size of a memory region with effective results of processing held therein; and a second pointer indicating an end address of a memory region which has been released by reading results of processing therefrom, and
the at least one block puts results of processing in response to a processing request in a memory region assigned therefor using the first and second pointers, in a first-in, first-out mode.

12. A data processing system, comprising:
a memory block for storing data;
a data-processing control block which assigns a memory region of the memory block for storing results of processing of stream data;
a demultiplex-processing block which demultiplexes multiplexed encoded data using the memory region assigned thereto on receipt of each processing request;
a decode-processing block which decodes the demultiplexed encoded data using the memory region assigned thereto on receipt of each processing request;
an encode-processing block which encodes input data using the memory region assigned thereto on receipt of each processing request; and
a multiplex-processing block which multiplexes the encoded data using the memory region assigned thereto on receipt of each processing request,
wherein the data-processing control block puts at least one of the demultiplex-processing block, decode-processing block, encode-processing block, and multiplex-processing block under its control, and
the data-processing control block changes a memory region to assign for each processing request based on results of processing conducted by the at least one block in response to a processing request precedent thereto.
